(19) United States
(12) Patent Application Publication
(10) Pub. No.: US 2008/0120436 A1
(43) Pub. Date: May 22, 2008

(54) Expansion Peripheral Techniques for Portable Audio Player

(75) Inventors: Clayton N. Cowgill, (US); Mathew Schneider, (US)

Correspondence Address: TOLER LAW GROUP, 8500 BLUFFSTONE COVE, SUITE A201, AUSTIN, TX, 78759, US

(73) Assignee: SIGMATEL, INC.

(21) Appl. No.: 12/022,973

(22) Filed: Jan. 30, 2008

Related U.S. Application Data
(62) Division of application No. 10/066,552, filed on Jan. 31, 2002.

(51) Int. Cl. G06F 3/00

(52) U.S. Cl. 710/2

(57) ABSTRACT

In an embodiment, a portable audio player includes a processor adapted to receive movement data from a peripheral device and to select an audio track to be played based on the movement data.

### FIELD OF THE INVENTION

The invention relates to portable audio players, and more particularly, to expansion peripheral techniques for a portable audio player.

### BACKGROUND OF THE INVENTION

Portable audio players afford users access to their preferred music and other audio selections anywhere at anyplace at anytime—a highly desirable benefit and significant convenience to the user. Such portable audio players typically store audio files in a digital format in a non-volatile storage area such as a magnetic disk or flash memory. It is also possible that selected audio files could be stored in analog format on magnetic tape or other conventional analog storage means. Regardless of the format of the stored audio files, portable audio players typically have some storage capability for storing selected audio files for the user's playback enjoyment. Because portable audio files tend to be large in size (e.g., a typical MP3 digital music file is about three to five megabytes), portable audio players generally are equipped with a significant amount of storage space to accommodate a number of such audio files.

In addition, portable audio players can have other features such as a rechargeable power source and a user interface for allowing the user to interact with the portable audio player. Likewise, portable audio players can have a data port for receiving data such as audio data files or commands from a remote control using pre-established protocols associated with the portable audio player. Some portable audio players further include display capabilities. The display is located locally on some such portable audio players, while other such portable audio players have a detachable display where data is presented to the display from the portable audio player via a data port using pre-established protocols associated with the portable audio player.

A number of disadvantages and problems are associated with such portable audio players. For example, a data port of a portable audio player is generally only capable of one-way communication in the context of a pre-established protocol associated with the portable audio player. In addition, the peripheral devices that can be used with a portable audio player must possess certain performance criteria in order to function within the context of the pre-established protocols associated with the portable audio player. As such, peripheral devices are required to have componentry that is not necessarily commensurate with the intended application of the peripheral device. For instance, an otherwise inexpensive peripheral device that only requires a low bit rate (e.g., 300 bits per second (BPS)) to effect its purpose may be required to include more expensive componentry that facilitates a higher bit rate (e.g., 19,200 BPS) that suits the pre-established protocols associated with the host portable audio player. In short, the inflexibility of pre-established protocols associated with the portable audio player dictate the componentry of peripheral devices thereby reducing the autonomy of such peripheral devices.

Additionally, resources associated with portable audio players are generally under utilized. For example, storage area available in the portable audio player may not always be utilized to its fullest capacity (e.g., up to 3 megabytes of free space). Likewise, a display available on the portable audio player may not always be active. Similarly, a rechargeable power supply may never be depleted below a certain threshold while powering the portable audio player between charging sessions. Such resources could be beneficially exploited by a number of peripheral devices. However, conventional portable audio players do not allow for such exploitation, and the otherwise available resources remain under utilized.

There is a need, therefore, for a portable audio player that is capable of bi-directional communication with a number of autonomous peripheral devices having diverse communication bit rates. Such peripheral devices could exploit the available resources of a portable audio player such as its unused storage space, display capability, power supply and data port. In a more general sense, there is a need for a discovery protocol that allows a host device to determine the bit rate at which an autonomous peripheral device is communicating, and to adapt the host device bit rate of the to the peripheral device bit rate.

### BRIEF SUMMARY OF INVENTION

One embodiment of the present invention provides a portable audio player including a communication port for facilitating bi-directional communication between the portable audio player and a peripheral device, and a processor operatively coupled to the communication port, the processor for determining a bit rate associated with communications from the peripheral device.

Another embodiment of the present invention provides a portable audio player including a communication port for facilitating bi-directional communication between the portable audio player and a peripheral device, a transceiver operatively coupled to the communication port, the transceiver for transmitting data to the peripheral device and for receiving data from the peripheral device, and a processor for adapting the transceiver to a bit rate associated with the peripheral device.

Another embodiment of the present invention provides a method for establishing a bi-directional communication link between a portable audio player and a peripheral device. The method includes transmitting known data from the peripheral device to the portable audio player at a peripheral device bit rate, determining the peripheral device bit rate in response to the portable audio player recognizing the known data, and confirming a valid communication link at the peripheral device bit rate.

Another embodiment of the present invention provides a method for establishing a bi-directional communication link between a host device associated with a first bit rate and a peripheral device associated with a second bit rate. The method includes receiving a known character from the peripheral device at the second bit rate at the host device. In response to the host device not recognizing the known character, the method includes adjusting the first bit rate, and repeating the receiving and adjusting steps until the host recognizes the known character thereby indicating that the adjusted first bit rate matches the second bit rate. In response to the host device recognizing the known character, the method further includes transmitting a reply character at the adjusted first bit rate to the peripheral device to confirm a valid bi-directional communication link between the host device and the peripheral device.

Another embodiment of the present invention provides a method for establishing a bi-directional communication link between a host device and a peripheral device. The method includes transmitting a known character from the peripheral device to the host device at a peripheral device bit rate, receiving a reply character at the peripheral device from the host device at a target bit rate that potentially matches the peripheral device bit rate. In response the reply character matching a known reply character, the method includes confirming the target bit rate as matching the peripheral device bit rate thereby establishing a valid bi-directional communication link between the host device and the peripheral device.

The features and advantages described in the specification are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1a illustrates a portable audio player and peripheral system in accordance with one embodiment of the present invention.

FIG. 1b illustrates a portable audio player and peripheral system in accordance with another embodiment of the present invention.

FIG. 2a illustrates a method for establishing a bi-directional communication link between a portable audio player and a peripheral device in accordance with one embodiment of the present invention.

FIG. 2b illustrates a method for establishing a bidirectional communication link between a host device and a peripheral device in accordance with one embodiment of the present invention.

### DETAILED DESCRIPTION OF THE INVENTION

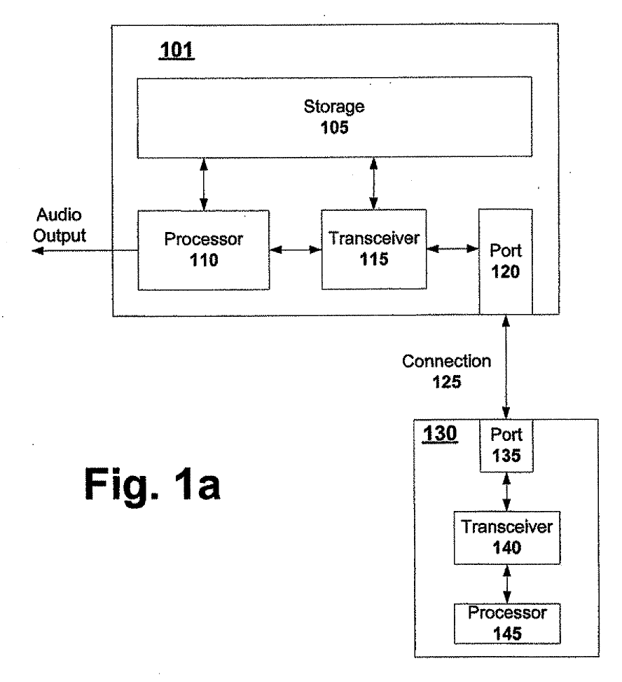

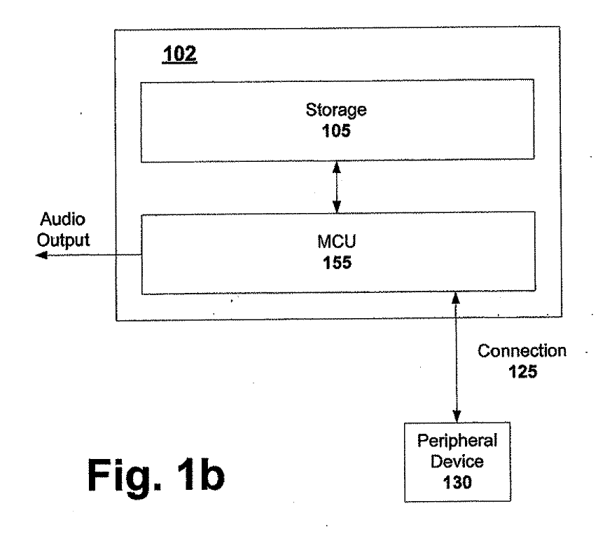

FIG. 1a illustrates a portable audio player and peripheral system in accordance with one embodiment of the present invention. Portable audio player 101 includes storage 105, processor 110, transceiver 115, and port 120. A peripheral device 130 is coupled to portable audio player 101 via connection 125. Peripheral device 130 includes port 135, transceiver 140, and processor 145. An audio output is provided by processor 110. Note that portable audio player 101 can include other components not shown in FIG. 1a, such as a user interface and a display. In such an embodiment, signals from user interface buttons could be received by processor 110, and display information could be presented to the display by processor 110. In addition, portable audio player 101 includes a power source such as a battery (e.g., rechargeable nickel cadmium). Other components and configurations will be apparent in light of this disclosure (e.g., additional data ports, digital to analog converter, amplifier, speakers and headphone jack). Portable audio player 101 can also have less components (e.g., see FIG. 1b).

Note that although this disclosure focuses on portable audio players, other types of portable electronic devices can also incorporate the principles of the present invention, such as a personal digital assistant, a portable video player, or any portable electronic device that can act as a host and resource to the benefit of a peripheral device.

Peripheral device 130 can also have more or less components, and the embodiment shown in FIG. 1a is not intended to limit the present invention. The componentry that makes up peripheral device 130 depends on factors such as the particular application for which the device was designed and desired performance criteria. Other components and configurations will be apparent in light of this disclosure (e.g., power supply, storage, RAM, ROM, display, and function specific circuitry). For instance, in the event that the user could not free a hand to engage peripheral device 130, peripheral device 130 could have a conventional voice translation module for interpreting a user's voice commands and issuing the corresponding control signals or commands to give effect to those voice commands.

Overview

A portable audio player allows a user to enjoy audio media such as music and audio books without being constrained to any one geographic location. The audio media can be in a number of formats including digital and analog, and can be stored in storage 105. The audio media can be downloaded to storage 105 via a data port such as port 120 from a source such as a computer, boom box, tape deck, compact disc player, or an online digital audio media supplier. The user can access and playback each piece of stored audio media as desired. For instance, the audio output can be coupled to a pair of headphones or the like donned by the user. Similarly, the audio output can be operatively coupled to a speaker.

Generally, peripheral device 130 can be any one of a number of devices included in a family of peripheral devices that function with portable audio player 101. For example, peripheral device 130 can be a remote control (e.g., with or without display), remote display, drum pad, tuner, radio transmitter, pulse-rate monitor, pedometer, or speedometer. Alternatively, peripheral device 130 can represent a network node or a computer system. In short, peripheral device 130 can be any one of a number of devices or systems that could benefit from the exploitation of functionalities included in portable audio player 101, or could be operatively coupled with portable audio player 101 for an intended communicative purpose.

Peripheral device 130 can provide peripheral data to portable audio player 101 via data port 120 over connection 125. Such peripheral data can be received by transceiver 115 and stored in storage 105. Peripheral data need not be audio-type data, but can be any type of data depending on the particular application of peripheral device 130. Consider the example where peripheral device 130 is a pulse-rate monitor, pedometer, or a speedometer. As the user jogs or bicycles while listening to music on portable audio player 101, peripheral device 130 can be monitoring the user's pulse-rate, mileage or speed. This monitored peripheral data can then be provided to portable audio player 101 for storage, and will thus be available for later downloading to, for example, a computer application that is configured to receive, store, chart and otherwise manipulate the monitored peripheral data.

Similarly, peripheral data can be received by transceiver 115 and displayed on a display included in portable audio player 101 (thus allowing the user to adjust the exercise pace accordingly). Peripheral data received by transceiver 115 might also be control data that dictates the performance of portable audio player 101. Consider, for example, the application where peripheral device 130 is a pulse-rate monitor used in conjunction with portable audio player 101 during a user's exercise regime. The pulse-rate monitor 130 can signal an increased pulse rate (e.g., based on a pre-established threshold such as 125 beats per minute) to portable audio player 101. Portable audio player 101 can respond to the signal, for example, by automatically increasing the volume to a predetermined level, or selecting an inspirational music track such as a favored rock-and-roll song or a symphonic masterpiece. The predetermined volume level and the selected inspirational track could be based on established user preferences. Regardless of the type of peripheral data received by transceiver 115, processor 110 can effect a procedure (e.g., a set of software instructions) on the peripheral data, such as digital compression or conversion to a particular format. Likewise, processor 110 can effect a procedure in response to the peripheral data, such as music selection and volume control.

Peripheral device 130, on the other hand, can receive data and power from portable audio player 101 via port 120 over connection 125. For instance, data can be extracted from storage 105, manipulated by processor 110 (e.g., decompressed or processed into packets), and transmitted by transceiver 115 to peripheral device 130 via port 120. Consider, for example, the application where peripheral device 130 is a remote control having an integrated display. In such an embodiment, portable audio player 101 could be strapped to the user's arm (or otherwise secured on the user), while the remote control could be held in the user's hand or fixedly located in the user's view and reach or voice range (e.g., on the handlebars of a bicycle or the control panel of a rowing machine). In this way, the user could readily control portable audio player 101 while simultaneously having a visual display as to the likes of upcoming music and song lyrics.

Each of the components shown in FIG. 1a will now be discussed in more detail.

Components

Storage 105 can be implemented by a number of conventional storage devices. For example, storage 105 can be a magnetic hard drive, disk, tape or film capable of storing audio media. Similarly, storage 105 can be implemented with a number of non-volatile memory chips such as read only memory (ROM), electronic erasable programmable ROM (EEPROM), or flash memory chips. Other known forms of non-volatile storage devices and memory chips can be used here as well.

Port 120 allows peripheral device 130 to be coupled via connection 125 to portable audio player 101. In one embodiment, port 120 is a RS-232C port and connection 125 includes a two-wire serial bus where one of the wires is for transmitting data to peripheral device 130, and the other wire is for receiving data from peripheral device 130. In an alternative embodiment, a logic level implementation of RS-232C is used to effect port 120, where the communicated signals range from a logic low (about ground) to a logic high (about 3.3 to 5 volts). In such an embodiment, the need for a level shifting circuitry typically used in RS-232C to effect a +/−12 volt range is eliminated. Other serial port technologies or variations thereof can be used here as well, such as RS-422, RS-423, universal serial bus (USB), and IEEE 1394. Parallel port technologies, such as small computer system interface (SCSI) ports, Centronics-type ports, enhanced parallel ports (EPP), and extended capabilities port (ECP) can also be employed to effect the communicative purpose of port 120.

Note that although port 120 and transceiver 115 are shown as separate components, their individual functionalities may be integrated into a single component where port 120 is essentially an input/output (I/O) port to transceiver 115. Transceiver 115 provides a transmitter and receiver functionality to portable audio player 101 and can be implemented in conventional technologies, whether by software, hardware, firmware or some combination thereof.

Further note that connection 125 can be implemented by conventional wireless technology. In such an embodiment port 120 might be replaced by an antenna coupled to transceiver 115, the antenna and transceiver configured to transmit/send radio frequency or microwave wireless communications. Alternatively, port 120 might be replaced by a window or lens coupled to transceiver 115, the window and transceiver configured to transmit/send infrared communications. Transceiver 115 can perform any necessary processing of the data (e.g., coding, decoding and filtering) to facilitate wireless communication.

The technologies chosen to effect the likes of connection 125, port 120 and transceiver 115 depends on factors such as distance of connection 125, desired speed of communication over connection 125, the number of communication paths, channels or bus wires that make up connection 125, the type of interface (e.g., serial or parallel) and the type of connection 125 (e.g., wired or wireless). Thus, the present invention is not intended to be limited to any one embodiment or configuration employing such technologies. Rather, a number of configurations can be used to achieve the overall intended communicative purpose.

Processor 110 can be implemented by a conventional microprocessor or central processing unit (CPU). The processing power of processor 110 depends on factors such as per unit cost and desired performance of portable audio player 101. Processor 110 might also include (or have access to) support functions such as RAM/ROM where a set of software instructions can be stored for carrying out specific functions or tasks such as digital compression/decompression, data conversion (e.g., digital to analog and vice versa), and data formatting (e.g., packetizing and depacketizing). A number of other functions that can be carried out by a process running on processor 110 will be apparent in light of this disclosure. For example, searching functions, organizing functions, security functions, menu functions, display functions, playlist or similar programming functions, and user preference-based functions such as music selection or volume control based on elevated pulse-rate signal.

In addition, processor 110 can be used to effect a discovery and handshaking protocol that allows the bit rate of a peripheral device to be determined so that a communication link can be established between portable audio player 101 and peripheral device 130. This discovery and handshaking protocol can be initiated by portable audio player 101 or by peripheral device 130. In one embodiment, the discovery and handshaking protocol is initiated by peripheral device 130 upon power up, which occurs when peripheral device 130 is coupled to port 120 via connection 125, Note that in this particular embodiment, power is provided to peripheral device 130 from portable audio player 101 via connection 125. However, peripheral device 130 can also have its own power source. Regardless, peripheral device 130 begins a training sequence by transmitting a known character upon powering up. For example, peripheral device 130 might transmit a “+” character, although any known character could be used.

In response to sensing activity at port 120 (e.g., as reported by transceiver 115), processor 110 adjusts the bit rate of transceiver 115 until the known character is recognized by processor 110. Once the known character is recognized, a known reply character (e.g., “=” or other pre-established reply character) is transmitted from portable audio player 101 to peripheral device 130 at the bit rate at which the known character was recognized by processor 110. If peripheral device 130 recognizes the known reply character, then the discovery and handshaking process is complete. The bit rate of the peripheral device is now known by portable audio player 101, and a bi-directional communication link between portable audio player 101 and peripheral device 130 is established. A conventional communication protocol can now be implemented to effect the exchange of information between the two devices.

Note that in alternative embodiments, additional steps can be added to the discovery and handshaking process to ensure a robust and valid communication link is established. For instance, in response to peripheral device 130 receiving and recognizing the reply character transmitted from portable audio player 101, peripheral device 130 can then transmit a second known character (e.g., “S”). In response to portable audio player 101 receiving and recognizing the second known character, portable audio player 101 can reply with a second known reply character (e.g., “&”). A valid communication link is established if peripheral device 130 receives and recognizes the second known reply character. Using such a multiple iteration training sequence between portable audio player 101 and peripheral device 130 during the discovery and handshaking process ensures that the communication link cannot be accidentally negotiated by the likes of aliasing at different bit rates or other fluke events.

Other variations on the discovery and handshaking protocol will be apparent in light of this disclosure. For instance, the discovery and handshaking process could be initiated by portable audio player 101 in response to sensing received data at port 120. In such an embodiment, portable audio player 101 can respond by commanding peripheral device 130 into a training mode where an exchange of known characters as described herein is performed so that the bit rate of peripheral device 130 can be determined. Similarly, the user can manually initiate a training sequence after coupling a peripheral device 130 to portable audio player 101 by, for example, pressing a training initiation button. Such a training initiation button could be located on either or both of peripheral device 130 and portable audio player 101, and operatively coupled to a corresponding processor that initiates the training sequence in response to the button being pressed.

Once the bit rate associated with peripheral device 130 is determined and a valid bi-directional communication link is established between portable audio player 101 and peripheral device 130, then processor 110 can effect a communication protocol for exchanging information between portable audio player 101 and peripheral device 130. In one embodiment, processor 110 effects a packet-based communication protocol. Checksums and timeouts can be used in conjunction with packet acknowledgments to ensure that packets are delivered providing the communication link has not failed. If the link does fail, the discovery and handshaking process can automatically restart to re-establish communication between portable audio player 101 and peripheral device 130.

The packet protocol may include commands for common functions such as get data functions, read data functions, write data functions, and store data functions. Likewise, the packet protocol might include commands for specialized functions that are suitable only for certain peripheral devices 130, such as a display data function or a user preference-based function. Conventional protocols other than packet-based protocols can also be used for effecting the exchange of information between the devices.

Port 135, transceiver 140 and processor 145 of peripheral device 130 can be functionally similar to port 120, transceiver 115 and processor 110 of portable audio player 101, respectively. Thus, the earlier discussion with regards to these components equally applies here with the difference that port 135, transceiver 140 and processor 145 reside and operate in the context of peripheral device 130 as opposed to portable audio player 101. In an alternative embodiment, the functionality of port 135, transceiver 140 and processor 145 can be implemented in a microcontroller unit or equivalent processing environment as discussed in reference to FIG. 1b. Regardless of how peripheral device 130 is implemented, it has the ability to transmit/receive data to/from portable audio player 101 at a bit rate that is commensurate with the application associated with peripheral device 130. In this sense, peripheral device 130 is autonomous. Processor 145 (or its equivalent) can effect processes and procedures that are specific to the application of peripheral device 130. In addition, processor 145 can effect the discovery and handshaking protocol, as well as the communication protocol in conjunction with processor 110 (or its equivalent) of portable audio player 101.

FIG. 1b illustrates a portable audio player and peripheral system in accordance with another embodiment of the present invention. Portable audio player 102 is functionally similar to portable audio player 101 of FIG. 1a. Thus, relevant portions of the earlier discussion equally apply here with regards to storage 105, peripheral device 130, connection 125, and the overall functionality of the portable audio player and expansion peripheral system described herein. However, note that portable audio player 102 of FIG. 1b includes a microcontroller unit MCU) 155 instead of processor 110, transceiver 115, and port 120. In short, the functionality of these components can be included in MCU 155, or made accessible to MCU 155 just as transceiver 115 of FIG. 1a, for example, is made accessible to processor 110.

MCU 155 can include a microprocessor or central processing unit (CPU) that is capable of executing software instructions and procedures for the likes of carrying out specific functions or tasks such as digital compression/decompression, data conversion, data formatting, and other functions (e.g., as previously mentioned with reference to processor 110 of FIG. 1a). Similarly, MCU 155 can be used to effect the discovery and handshaking protocol that allows the bit rate of a peripheral device to be determined so that a communication link can be established as previously described. Once the bit rate associated with peripheral device 130 is determined and a valid bi-directional communication link is established between portable audio player 102 and peripheral device 130, then MCU 155 can effect a communication protocol (e.g., packet-based protocol) for exchanging information between portable audio player 102 and peripheral device 130 as described earlier.

MCU 155 may also include (or have access to) other support functions such as a number of universal asynchronous receiver transmitter (UART) circuits or transceivers, PO ports, additional CPUs, RAM, ROM, non-volatile memory devices (e.g., EEPROM or flash memory), comparators, buffers, logic units, timers, and other specific support functions. Other equivalent processing environments that can be configured to provide the described functionality herein can also be used in place of MCU 155, such as a single board computer.

In one embodiment, connection 125 includes a logic level implementation (about 0 to 5 volts) of a two-wire serial RS-232C type bus, wherein a first wire of the bus (e.g., for transmitting data to peripheral device 130) is coupled between one I/O port of MCU 155 and peripheral device 130, and a second wire of the bus (e.g., for transmitting data to MCU 155) is coupled between another I/O port of MCU 155 and peripheral device 130. In such an embodiment, a set of software instructions stored in MCU 155 can be used to effect any necessary processing (e.g., decompression, coding, formatting, conversion) of data in preparation for transmission to peripheral device 130. Likewise, a set of software instructions stored in MCI 155 can be used to effect any necessary processing (e.g., compression, decoding, formatting, conversion) of data received from peripheral device 130. Such software instructions can be, for example, stored in a ROM included in MCU 155, and retrieved to a RAM for execution by MCU 155. Numerous other function-specific processes and procedures can be implemented by the likes of hardware, software, firmware or any combination thereof included in MCU 155.

MCU 155 might include UARTs at each of the I/O ports. The UARTs convert parallel bytes from the processing module of MCU 155 into serial bits and transmit those bits to peripheral device 130. UARTs also, receive serial bits from peripheral device 130 and convert those bits into parallel bytes that can be efficiently used by the processing module. As previously explained, a number of technologies can be used to facilitate connection 125, and the present invention is not intended to be limited to any one particular embodiment. For instance, in an embodiment where connection 125 is a wireless connection, portable audio player 102 might include a transceiver that receives wireless transmissions, converts them to a packet-based signal, and provides that signal to an I/O port of MCU 155 for manipulation or processing (assuming that MCU 155 does not include the transceiver). Similarly, MCU 155 could provide packet-based data to a transceiver via an I/O port of MCU 155. The transceiver could then convert that packet-based data to a wireless transmission (e.g., radio frequency or infrared) to be received by peripheral device 130.

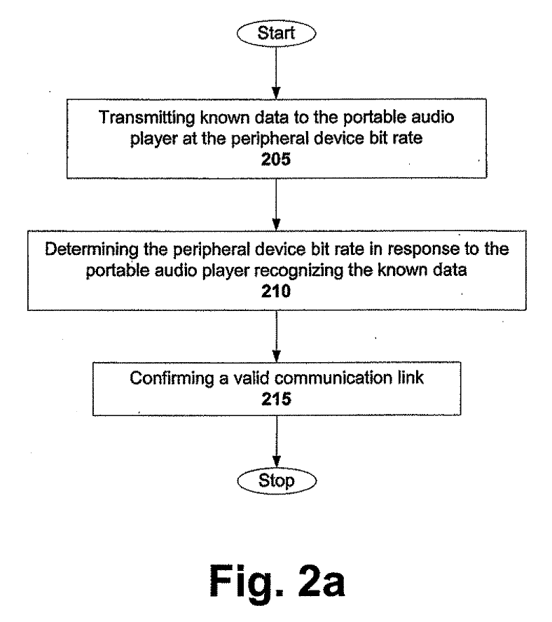

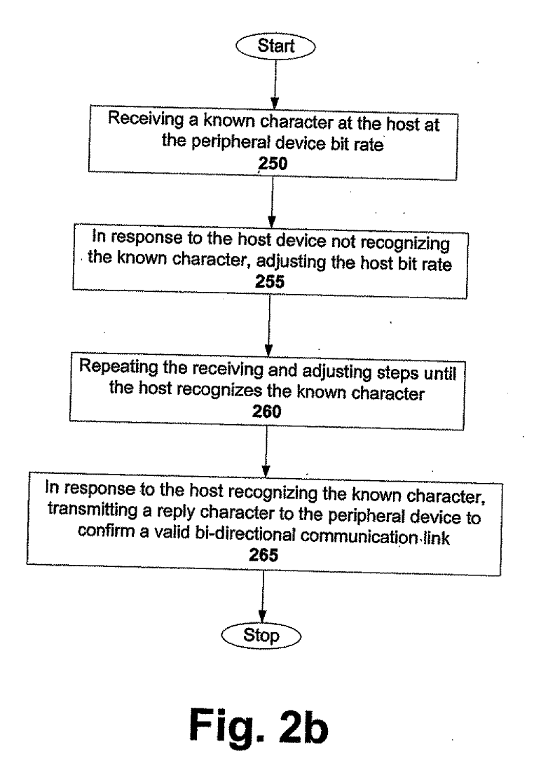

FIG. 2a illustrates a method for establishing a bi-directional communication link between a portable audio player and a peripheral device in accordance with one embodiment of the present invention. This method may be implemented, for example, by software instructions running on a processor (e.g., processor 110 or MCU 155). The method begins with transmitting 205 known data to the portable audio player at the peripheral device bit rate. In one embodiment, this transmission includes a single known character (e.g., “+”), and is initiated in response to the peripheral device being coupled to the portable audio player via a connection (e.g., connection 125). The peripheral device can use the power of the portable audio player as previously explained. The presence of power, whether provided by the peripheral device itself or by the portable audio player, can signal the start of the method (e.g., step 205).

In one embodiment, the peripheral device will wait a first pre-established period of time (e.g., 50 milliseconds from time known character was transmitted) for a reply from the portable audio player. If no reply is received within the first pre-established period of time, the peripheral device repeats step 205. In the event that no reply is received after a number of attempts (e.g., 160) to establish communication, the peripheral device can signal an error condition and stop communication attempts with the portable audio player. The error condition can be signaled, for example, via an illuminated LED or a “host device not found” message displayed on a display of the peripheral device. Error routines running on a processing module of the peripheral device can be employed to effect such manifestations.

The method proceeds with determining 210 the peripheral device bit rate in response to the portable audio player recognizing the known data. In one embodiment, the portable audio player will wait to receive a character via its data port thereby signaling the start of the training sequence. If more than one character is received in the first pre-established period of time thereby indicating the current portable audio player bit rate does not match the peripheral device bit rate, then the received data will be discarded. The portable audio player will then adjust its bit rate to a next value, and will continue to wait for the single known character.

However, if only a single character is received by the portable audio player, the portable audio player can be programmed to wait a second pre-established period of time that is slightly longer than the first pre-established period of time but not greater than twice the first pre-established period of time (e.g., 75 milliseconds from receipt of the first single character) to receive the character again. If no character is received within that second pre-established period of time, the portable audio player discards any received data and continues to wait for the known character. On the other hand, if a single character is received within the second pre-established period of time, it is checked to determine if it matches the known character. If it does not match, then the portable audio player discards any received data and continues to wait for the known character.

If, however, the single character does match the known character, then the corresponding bit rate of the portable audio player is noted as the target bit rate. The method proceeds with confirming 215 a valid communication link. In one embodiment, this confirmation is effected by the portable audio player transmitting a known reply character (e.g., “=”) to the peripheral device at the target bit rate. In response to the peripheral device recognizing the known reply character, the target bit rate is confirmed, and the communication link is declared established. In such an embodiment, if the peripheral device receives a reply character within the first pre-established period of time, that reply character is checked to see if it matches the known reply character. If it does not match the known reply character, then the peripheral device goes back to step 205 and the discovery and handshaking process begins again. On the other hand, if the reply character received by the peripheral device does match the known reply character, then the target bit rate can be confirmed and the communication link can be established.

In alternative embodiments, additional steps can be performed to ensure a robust and valid communication link. For instance, once the peripheral device receives the known reply character, the peripheral device can transmit a second known character (e.g., “−”). The peripheral device then waits a third pre-established period of time (e.g., 100 milliseconds from time second known character was transmitted) for a reply from the portable audio player. If no reply is received within the third pre-established period of time, the peripheral device goes back to step 205 and the discovery and handshaking process starts over.

In such an embodiment, the portable audio player can be programmed to wait a fourth pre-established period of time that is slightly longer than the third pre-established period of time but not greater than twice the third pre-established period of time (e.g., 150 milliseconds from sending the first reply character) to receive the second known character. If the second known character isn't received in the fourth pre-established period of time, then the portable audio player repeats step 210. If a character is received within the fourth pre-established period of time, then it is checked to see if it matches the second known character transmitted by the peripheral device. If it does not match, then the portable audio player repeats step 210. If it does match, however, the portable audio player can reply with a second reply character (e.g., “&”) thereby confirming the target bit rate and the establishment of the communication link.

FIG. 2b illustrates a method for establishing a bi-directional communication link between a host device and a peripheral device in accordance with one embodiment of the present invention. This method may be implemented, for example, by software instructions running on the likes of processor or MCU as indicated with reference to FIG. 2a. The method begins with receiving 250 a known character at the host at the peripheral device bit rate. In response to the host device not recognizing the known character, the method proceeds with adjusting 255 the host bit rate. The method further includes repeating 260 the receiving and adjusting steps until the host recognizes the known character thereby indicating that the adjusted first bit rate matches the second bit rate, or it otherwise on target. In response to the host recognizing the known character, the method includes transmitting 265 a reply character to the peripheral device to confirm a valid bi-directional communication link. Note that the reply character is transmitted at the bit rate associated with the host when it recognized the known character (referred to as the target bit rate). In alternative embodiments, additional steps can be performed to ensure a robust and valid communication link is established as previously explained.

The foregoing description of the embodiments of the invention has been presented for the purposes of illustration and description. It is not intended to be exhaustive or to limit the invention to the precise form disclosed. Many modifications and variations are possible in light of this disclosure. For instance, either the host device or the peripheral device can initiate the discovery and handshake process, which can include any number of iterations to ensure a valid link is established. The known data used in the discovery and handshake process can be a single character, symbols phrase or an otherwise expected value or event. It is intended that the scope of the invention be limited not by this detailed description, but rather by the claims appended hereto.

What is claimed is:

1. A portable audio player comprising:
a memory to store data associated with a plurality of audio tracks;
an audio output adapted to play one or more of the plurality of audio tracks; and
a processor coupled to the memory and further coupled to the audio output, the processor adapted to receive movement data from a peripheral device, the movement data associated with a user of the peripheral device, the possessor further adapted to select one of the plurality of audio tracks to be played via the audio output based on the movement data.

2. The portable audio player of claim 1, wherein the peripheral device is a speedometer and the movement data indicates a speed.

3. The portable audio player of claim 1, wherein the peripheral device is a pedometer and the movement data indicates a distance.

4. The portable audio player of claim 1, further comprising a communication port that is adapted to receive the movement data from the peripheral device.

5. The portable audio player of claim 1, wherein the processor is adapted to select an audio track from the plurality of audio tracks to be played based on a particular level of the movement data.

6. The portable audio player of claim 1, wherein the processor is further adapted to adjust a volume of the audio output based on the movement data.

7. The portable audio player of claim 6, wherein the processor is adapted to adjust the volume of the audio output to a pre-determined volume level based on a particular value of the movement data.

8. The portable audio player of claim 1, further comprising:
a communication port to couple the portable audio player to the peripheral device;
a transceiver coupled to the communication port and further coupled to the processor; and
wherein the processor is adapted to receive a character from the peripheral device and to adjust a bit rate of the transceiver until the character is recognized, the processor being further adapted to receive the movement data from the peripheral device via the transceiver at the adjusted bit rate.

9. The portable audio player of claim 8, wherein the processor is further adapted to send information associated with the selected one of the plurality of audio tracks to the peripheral device via the transceiver at the adjusted bit rate to display to the user of the peripheral device.

10. A method of operating a portable audio player, the method comprising:
receiving movement data from a peripheral device, the movement data associated with a user of the peripheral device;
selecting an audio track of a plurality of audio tracks stored in a memory of the portable audio player based on the movement data; and
playing the selected audio track via an audio output of the portable audio player.

11. The method of claim 10, wherein the peripheral device includes a speedometer and the movement indicates speed of movement of the user.

12. The method of claim 10, wherein the peripheral device includes a pedometer and the movement data provided by the pedometer indicates a distance traveled by the user.

13. The method of claim 10, wherein the audio track is selected based on a particular level of the movement data received from the peripheral device.

14. The method of claim 10, further comprising adjusting a volume of the audio output based on the movement data.

15. The method claim 14, wherein the volume of the audio output is adjusted to a predetermined volume level based on a particular level of the movement.

16. The method of claim 10, further comprising;
receiving a character from the peripheral device;
adjusting a bit rate of a transceiver to enable recognition of the character; and
receiving the movement data associated with the user from the peripheral device using the adjusted bit rate.

17. The method of claim 16, further comprising sending information associated with the selected audio track at the adjusted bit rate o the peripheral device to display.
